(19) United States
(12) Patent Application Publication
(10) Pub. No.: US 2020/0352204 A1
(43) Pub. Date: Nov. 12, 2020

(54) STABLE, SPRAY-DRIED PARTICLES AND PROCESS FOR OBTAINING SAME

(71) Applicant: Givaudan SA, Vernier (CH)

(72) Inventors: Gregory Alan SHERMAN, Cincinnati, OH (US); Michael CHANEY, Covington, KY (US); Aloysius DOORN, Zeewolde (NL)

(21) Appl. No.: 16/760,063

(22) PCT Filed: Nov. 26, 2018
(86) PCT No.: PCT/EP2018/082531

§ 371 Date: Apr. 29, 2020

Related U.S. Application Data
(60) Provisional application No. 62/593,217, filed on Nov. 30, 2017.

(51) Int. Cl. A23L 27/00; A23L 29/10; A23L 29/30; A23L 3/46; A23L 33/21; A23L 27/12

(52) U.S. Cl. CPC A23L 27/72; A23L 29/10; A23L 27/12; A23L 3/46; A23L 33/21; A23L 29/30

(57) ABSTRACT

Stable spray-dried particles are provided. The stable spray-dried particles include a water-soluble foodstuff matrix including from about 0.1% to about 60% emulsifier and from about 40% to about 99.9% filler, based on the total weight of the foodstuff matrix; and at least one active component encapsulated in the foodstuff matrix. The emulsifier is potato protein and the filler is selected from the group consisting of glucose syrup, soluble fibers and mixtures thereof.

### FIELD OF THE INVENTION

The present disclosure relates to moisture and oxygen stable spray-dried particles including at least one volatile active component and methods of producing such particles. More particularly, the present disclosure relates to stable spray-dried particles including at least one volatile active component encapsulated in a matrix made from foodstuffs.

### BACKGROUND OF THE INVENTION

Encapsulating volatile components in a solid encapsulating matrix is a well-known method. The advantages are numerous and include, for example, (i) the protection of the volatile component against undesired evaporation during storage, (ii) the protection of chemically sensitive components against chemical degradation, such as oxidation and hydrolysis, and (iii) the possibility to control the release of the encapsulated component.

Numerous methods can be used to produce solids comprising encapsulated volatile ingredients. However, the most common and economical way to encapsulate a volatile component involves the step of emulsifying the volatile component in an aqueous phase comprising encapsulating materials to form an oil-in-water emulsion and drying this emulsion by spray drying, spray granulation or spray coating to obtain a dry emulsion. The morphology of the dry product is that of a multitude of oil droplets in a glassy, polar, encapsulating matrix. The polar, encapsulating matrix is usually based on carbohydrate materials, such as modified starches, maltodextrins, and gums.

More and more consumers see these types of encapsulating matrices, especially modified starches, as something which is chemical or artificial and thus not desired. As a result, one such trend is the drive towards so-called “clean label” products. More specifically, the demand from customers and consumers is, in particular, directed to products that are free from artificial ingredients, which include modified starches and maltodextrins currently used as encapsulation ingredients. For labelling purposes, such ingredients are treated as additives and their presence in a product must be specifically listed as such in its labelling.

Consumers are looking for naturalness and simplicity. Less ingredients in a product means a shorter ingredient list on food and beverage packaging. If food labels are more likely to be read by people trying to avoid certain food ingredients, then using items of food, i.e. foodstuffs, rather than through the addition of artificial ingredients, results in a shorter and simpler ingredient list, which is commonly referred to as “clean-labelling”.

There remains a need to provide spray dry carriers that are comprised entirely or substantially entirely of foodstuffs, which can deliver superior authentic flavour to food or beverage products, and which can further benefit customers and consumers by achieving the foregoing whilst contributing to a cleaner label for the food or beverage product.

### SUMMARY OF THE INVENTION

In one embodiment, stable spray-dried particles include a water-soluble foodstuff matrix including from about 0.1% to about 60% potato protein and from about 40% to about 99.9% filler, based on the total weight of the foodstuff matrix; and at least one active component, encapsulated in the foodstuff matrix. The filler is selected from the group consisting of glucose syrup, soluble fibers and combinations thereof.

In another embodiment, stable spray-dried particles include a water-soluble foodstuff matrix including from about 0.1% to about 60% emulsifier and from about 40% to about 99.9% filler, based on the total weight of the foodstuff matrix; and at least one flavour ingredient encapsulated in the foodstuff matrix. The emulsifier is selected from the group consisting of beef stock protein, beef bone marrow extract, chicken stock protein, chicken gelatin, citrus pectin, egg yolk, albumin, gelatin hydrolysate, pork stock protein, sugar beet pectin, turkey stock protein, whey protein concentrate, soy protein, yogurt, non-fat milk solids, quillaja, pea protein, chickpea protein, rice bran proteins and mixtures thereof; and the filler is selected from the group consisting of glucose syrup, soluble fibers and mixtures thereof.

In yet another embodiment, a process for preparing stable spray-dried particles includes the steps of a) preparing a water-soluble foodstuff matrix including from about 0.1% to about 60% potato protein and from about 40% to about 99.9% filler; b) dissolving the foodstuff matrix in water; c) adding an active component; d) mixing the foodstuff matrix and active component under high shear to form an emulsion; and e) drying the emulsion.

These and other features, aspects and advantages of specific embodiments will become evident to those skilled in the art from a reading of the present disclosure.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure relates to spray-dried particles having a water-soluble foodstuff matrix and a volatile active component encapsulated therein. The foodstuff matrix according to the present disclosure includes the combination of an emulsifier and a filler. The spray-dried particles may also include other optional ingredients for particular applications and functionality, for example, water soluble vegetable and fruit concentrates may be used as natural plasticizers to assist with high load encapsulations. The term “emulsifier”, as used herein, is intended to mean a surface-active agent that facilitates the mixing of two or more liquid substances that would separate into its component parts under normal conditions. In one embodiment, the emulsifier is potato protein. Potato proteins are highly functional, in terms of excellent solubility and good emulsifying and foaming abilities. Potato is a cheap and widely available produce, and its proteins have a high nutritional value compared to most major plant proteins and close to that of egg proteins. Importantly, potato proteins are considered GRAS and non-allergenic and hence are not included in the list of known food allergens, which must be declared on the label. Further, potato proteins may be Kosher and Halal certified and non-GMO.

The amount of potato protein present in the foodstuff matrix can vary widely and may be based on the particular needs of the intended consumer, or the intended product form of the spray-dried particles. Also, the amount of potato protein present will depend on the percent flavour load, adjusted as needed to form a good emulsion to produce good encapsulation. In certain exemplary embodiments, potato protein may be present in an amount of 0.1% to 60% by weight of the foodstuff matrix. In another embodiment, potato protein may be present in an amount of 0.5% to 30% by weight of the foodstuff matrix. In another embodiment, potato protein may be present in an amount of 1% to 10% by weight of the foodstuff matrix. Potato proteins are commercially available in the form of concentrates and isolates containing 80% to 95% protein. They are available, for example. from Solanic, which is a subsidiary of AVEBE of Veedam, The Netherlands. Use of potato protein in the foodstuff matrix is also advantageous due to its particular concentration of certain amino acids.

In another embodiment, the emulsifier may be selected from beef stock protein, beef bone marrow extract, chicken stock protein, chicken gelatin, citrus pectin, egg yolk, albumin, gelatin hydrolysate, pork stock protein, sugar beet pectin, turkey stock protein, whey protein concentrate, soy protein, yogurt, non-fat milk solids, quillaja, pea protein, chickpea protein and rice bran proteins.

Another component of the foodstuff matrix according to the present disclosure is a filler. In one embodiment, the filler is selected from the group consisting of glucose syrup, soluble fibers and combinations thereof. The term “glucose syrup”, as used herein, refers to an aqueous composition containing glucose solids. Glucose syrup may also be referred to as glucose syrup solids, dried glucose syrup, dried potato syrup or potato syrup solids. Glucose syrup is a purified aqueous solution of nutritive saccharides obtained from edible starches having a dextrose equivalent greater than 20. It is primarily a food industry ingredient, belonging to the group starch hydrolysates or starch syrups. To produce glucose syrup, starch granules are extracted from vegetable raw materials (mostly corn, wheat, barley, rice, cassava and potato), and are treated with acids and/or microbial enzymes to produce the sweet syrup that is then purified and evaporated to the desired concentration. In one embodiment, the filler is potato glucose syrup. In certain exemplary embodiments, glucose syrup may be present in an amount of 40% to 99.9% by weight of the foodstuff matrix. In another embodiment, glucose syrup may be present in an amount of about 95% by weight of the foodstuff matrix. Potato glucose syrups are commercially for example, from AVEBE of Veedam, The Netherlands.

Soluble fibers can be derived from a variety of starch sources. In one embodiment, starch sources may include cereal grains (including corn, wheat, rice and combinations thereof) potato, or tapioca. When corn is used as the starting material, the soluble fiber composition is sometimes referred to as SCF (soluble corn fiber). While certain embodiments of the invention are described herein with reference to soluble corn fibers, the person of ordinary skill in the art will appreciate that other soluble fibers could be used in place of the soluble corn fibers in certain embodiments of the invention. In certain exemplary embodiments, soluble fibers may be present in an amount of 40% to 99.9% by weight of the foodstuff matrix. In another embodiment, soluble fibers may be present in an amount of about 95% by weight of the foodstuff matrix. Suitable commercial soluble corn fiber products include PROMITOR. Soluble Corn Fiber 70L or 70R available from Tate & Lyle Health & Nutrition Sciences, Hoffman Estates, Ill. and NUTRIOSE FM06 or FM10 available from Roquette America, Inc., Keokuk, Iowa.

In one embodiment, the foodstuff matrix includes at least one active component encapsulated therein. In one embodiment, the at least one active component is not restricted to a specific class of molecules. It. may refer to a substance, a compound, and/or an ingredient, alone or a mixture thereof.

In one embodiment, the at least one active component is selected from volatile flavours and fragrances. The terms “flavour or fragrance” encompass flavour or fragrance ingredients or compositions of current use in the flavour and/or fragrance industry, of both natural and synthetic origin. It includes single compounds and mixtures. Specific examples of such flavour or fragrance ingredients may be found in the current literature, e.g. in Fenaroli's Handbook of flavour ingredients, 1975, CRC Press; Synthetic Food adjuncts, 1947 by M. B. Jacobs, edited by Van Nostrand; or Perfume and Flavor Chemicals by S. Arctander, 1969, Montclair, N.J. (USA). The flavoring or perfuming ingredients may be present in the form of a mixture with solvents, adjuvants, additives and/or other components, generally those of current use in the flavours and fragrance industry.

In another embodiment, the at least one volatile active component may be selected from pharmaceuticals, vitamins, herbicides, fungicides, insecticides, detergents, cleaning agents and dyes.

Flavour and fragrance compositions may include a broad variety of mixtures of aromatic and fragrant ingredients, such as terpenes, terpene derivatives, esters, alcohols, ethers, ketones, lactones, aldehydes, anthranilates, nitriles, mercaptans, N- and S-heterocycles and the like.

Examples of suitable flavour ingredients include, but are not limited to, natural flavours, artificial flavours, spices, seasonings, synthetic flavour oils and flavoring aromatics and/or oils, oleoresins, essences, and distillates, and a combination comprising at least one of the foregoing.

Flavour oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavours such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavours imparted by a flavour ingredient include a milk flavour, a butter flavour, a cheese flavour, a cream flavour, and a yogurt flavour, a vanilla flavour, tea or coffee flavours, such as a green tea flavour, an oolong tea flavour, a tea flavour, a cocoa flavour, a chocolate flavour, and a coffee flavour; mint flavours, such as a peppermint flavour, a spearmint flavour, and a Japanese mint flavour; spicy flavours, such as an asafetida flavour, an ajowan flavour, an anise flavour, an angelica flavour, a fennel flavour, an allspice flavour, a cinnamon flavour, a chamomile flavour, a mustard flavour, a cardamom flavour, a caraway flavour, a cumin flavour, a clove flavour, a pepper flavour, a coriander flavour, a sassafras flavour, a savory flavour, a Zanthoxyli Fructus flavour, a perilla flavour, a juniper berry flavour, a ginger flavour, a star anise flavour, a horseradish flavour, a thyme flavour, a tarragon flavour, a dill flavour, a capsicum flavour, a nutmeg flavour, a basil flavour, a parsley flavour, a matjoram flavour, a rosemary flavour, a bayleaf flavour, and a wasabi (Japanese horseradish) flavour; a nut flavour such as an almond flavour, a hazelnut flavour, a macadamia nut flavour, a peanut flavour, a pecan flavour, a pistachio flavour, and a walnut flavour; floral flavours; and vegetable flavours, such as an onion flavour, a garlic flavour, a cabbage flavour, a carrot flavour, a celery flavour, mushroom flavour, and a tomato flavour.

According to some embodiments, flavour ingredients may also include aldehydes and esters such as cinnamyl acetate ((E)-3-phenylprop-2-en-1-yl acetate); cinnamaldehyde ((2E)-3-phenylprop-2-enal); citral diethylacetal ((E)-1,1-dimethoxy-3,7-dimethylocta-2,6-diene), dihydrocarvyl acetate (2-methyl-5-prop-1-en-2-ylcyclohexyl acetate), eugenyl formate ((2S)-1,3,3-trimethylbicyclo[2.2.1]heptan -2-yl acetate), p-methylanisol (1-methoxy-4-methylbenzene), and so forth can be used. Further examples of aldehyde flavourings include acetaldehyde (apple), benzaldehyde (cherry, almond), anisic aldehyde (4-methoxybenzaldehyde) (licorice, anise), cinnamic aldehyde ((2E)-3-phenylprop-2-enal) (cinnamon), citral (E)-3,7-dimethylocta-2,6-dienal), i.e., alpha-citral ((EE)-3,7-dimethylocta-2,6-dienal (lemon, lime), neral, i.e., beta-citral ((EZ)-3,7-dimethylocta-2,6-dienal (lemon, lime), decanal (orange, lemon), ethyl vanillin (vanilla, cream), heliotrope, i,e., piperonal (benzo[d][1,3]dioxole-5-carbaldehyde) (vanilla, cream), vanillin (vanilla, cream), alpha-amyl cinnamaldehyde ((E or Z)-2-benzylideneheptanal) (spicy fruity flavours), butyraldehyde (butanal) (butter, cheese), valeraldehyde (pentanal) (butter, cheese), citronellal (3,7-dimethyloct-6-enal) (modifies, many types), decanal (citrus fruits), aldehyde C-8 (octanal) (citrus fruits), aldehyde C-9 (nonanal) (citrus fruits), aldehyde C-12 (dodecanal) (citrus fruits), 2-ethyl butyraldehyde (2-ethyl.butanal) (berry fruits), hexenal, i.e., trans-2 hexenal (berry fruits), tolyl aldehyde (4-methylbenzaldehyde) (cherry, almond), veratraldehyde (3,4-di methoxybenzaldehyde) (vanilla), 2,6-dimethyl-5-heptenal, i.e., melonal (melon), 2,6-dimethyloctanal (green fruit), and 2-dodecenal (citrus, mandarin), and the like.

In another embodiment, flavour ingredients include natural compounds derived from Maillard reactions.

Examples of suitable fragrance ingredients include, but are not limited to hex-3-en-1-yl butyrate; 2-methyl-1-phenylpropan-2-yl acetate; 2-methyl-1-phenylpropan-2-yl butyrate; 4-(tert-butyl)cyclohexyl acetate; undecan-2-one; 2-benzylideneoctanal; 3,7-dimethylnona-1,6-dien-3-yl acetate; 3,7-dimethylocta-2,6-dien-1-yl acetate; 3,7-dimethylocta-2,6-dienal; non-6-enal; tridec-2-enenitrile; 1-((1,8a)-1,4,4,6-tetramethyl-2,3,3a,4,5,8-hexahydro-1-5,8a-methanoazulen-7-yl)ethanone; 1-(2,3,8,8-tetramethyl-1,2,3,4,5,6,7,8-octahydronaphthalen-2-yl)ethanone; 1-butoxy-1-oxopropan-2-yl butyrate; 2-methyl -1-phenylpropan-2-ol; allyl 2-(isopentyloxy)acetate; allyl 3-cyclohexylpropanoate; methyl non-2-ynoate; undec-9-enal; 1,3,4,5,6,7-hexahydro-.beta., 1,1,5,5-pentamethyl-2-2,4a-ethanonaphthalene-8-ethanol; 1-(1-ethoxyethoxy)hex-3-ene; 1-(2,6,6-trimethylcyclohex-3-en-1-yl)but-2-en-1-one; 1-(2,6,6-trimethylcyclohexa-1,3-dien-1-yl)but-2-en-1-one; 1,1-diethoxy-3,7-dimethylocta-2,6-diene; 2-ethyl-4-(2,2,3-trimethylcyclopent-3-en-1-yl)but-2-en-1-ol ; 3,7-dimethylnona-1,6-dien-3-ol ; 3,7-dimethylocta-2,6-dien-1-yl isobutyrate; 3-methyl -2-(pent-2-en-1-yl)cyclopent-2-enone; 4-(2,5,6,6-tetramethylcyclohex-2-en-1-yl)but-3-en-2-one; 4-(2,6,6-trimethylcyclohex-1-en-1-yl)but-3-en-2-one; 4-(2,6,6-trimethylcyclohex-2-en-1-yl)but-3-en-2-one; 1,3,3-trimethylbicyclo[2.2.1]heptan-2-yl acetate; (2,4)-1,7,7-trimethylbicyclo[2.2.1]heptan-2-yl acetate; (ethoxymethoxy)cyclododecane; 1-(2,6,6-trimethylcyclohexa-1,3-dien-1-yl)but-2-en-1-one; 3,4,5,6,6-pentamethylhept-3-en-2-one; 3,7,11-trimethyldodeca-1,6,10-trien-3-yl acetate; 3,7-dimethylocta-2,6-dien-1-ol; 3,7-dimethylocta-2,6-dienal ; 3-methyl-5-(2,2,3-trimethylcyclopent-3-en-1-yl)pent-4-en-2-ol ; 3-methyl cycl otetradec-5-enone; 4-((3a,7a)-hexahydro-1-4,7-methanoinden-5(6)-ylidene)butanal; 4-(2,6,6-trimethylcyclohex-2-en-1-yl)but-3-en-2-one; 4,11,11-trimethyl-8-methylenebicyclo[7.2.0]undec-4-ene; 4-methyldec-3-en-5-ol; 5-methylheptan-3-one oxime; methyl non-2-enoate; oxacyclohexadec-12-en-2-one; 1-((2-(tert-butyl)cyclohexyl)oxy)butan-2-ol; 1-(3,3-dimethylcyclohex-1-en-1-yl)pent-4-en-1-one; 1,2,4)-1,3,3-trimethylbicyclo[2.2.1]heptan-2-ol ; 1,2,4)-2′-isopropyl-1,7,7-trimethylspiro[bicyclo[2.2.1]heptane-2,4′-[1,3]dioxane]; 1,2,5)-2-ethoxy-2,6,6-trimethyl-9-methylenebicyclo[3.3.1]nonane; 112) (4-(4-hydroxyphenyl)butan-2-one; 1-methyl-2-(5-methylhex-4-en-2-yl)cyclopropyl)-methanol; 1-methyl-4-(4-methylpent-3-en-1-yl)cyclohex-3-enecarbaldehyde; 1-methyl-4-propan-2-ylcyclohexa-1,4-diene; (1s,4s)-1,3,3-trimethyl-2-oxabicyclo[2.2.2]octane; 2-(4-methylcyclohex-3-en-1-yl)propan-2-yl acetate; 2)-ethyl 3-isopropylbicyclo[2.2.1]hept-5-ene-2-carboxylate; 2,2-dimethoxyethyl)benzene; 2,6)-3,7-dimethylnona-2,6-dienenitrile; 2,6-dimethyloctan-2-ol; 2-isopropyl-5-methylcyclohexanol; 2-methyl-4-oxo-4-pyran-3-yl isobutyrate; 2-methyl -6-methyleneoct-7-en-2-yl acetate; 3-(4-isopropylphenyl)-2-methylpropanal ; 3,5,5-trimethylhexyl acetate; 3,5-dimethylhex-3-en-2-yl)oxy)-2-methylpropyl cyclopropanecarboxylate; 3,7-dimethyloct-6-en-1-yl acetate; 3,7-dimethyloct-6-en-1-yl formate; 3,7-dimethyloct-6-en-1-yl propionate; 3,7-dimethyloct-6-enenitrile; 3,7-dimethylocta-1,6-dien-3-yl acetate; (3a,4,7,7a)-ethyloctahydro-1-4,7-methanoindene-3a-carboxylate; (3a,6,7a)-3a,4,5,6,7,7a-hexahydro-1-4,7-methanoinden-6-yl acetate; (3a,6,7a)-3a,4,5,6,7,7a-hexahydro-1-4,7-methanoinden-6-yl isobutyrate; (3a,6,7a)-3a,4,5,6,7, 7a-hexahydro-1-4, 7-methanoinden-6-yl propionate; (3-methyl-2-pentylcyclopent-2-enone; 4, 7-dimethyloct-6-en-3-one; 4-methylene-2-phenyltetrahydro-2-pyran; 6,6-dimethoxy-2,5,5-trimethylhex-2-ene; allyl heptanoate; cyclohexyl 2-hydroxybenzoate; ethyl 2,6,6-trimethylcyclohexa-1,3-diene-1-carboxylate; ethyl heptanoate; ethyl hexanoate; hexyl isobutyrate; pentyl 2-hydroxybenzoate; propanedioic acid 1-(1-(3,3-dimethylcyclohexyl)ethyl) 3-ethyl ester; 3-methyl -4-(2,6,6-trimethylcyclohex-2-en-1-yl)but-3-en-2-one; 1-(3,3-dimethylcyclohexyl)ethyl formate; 1-(3,5,5,6,8,8-hexamethyl-5,6,7,8-tetrahydronaphthalen-2-yl)ethanone; 1-(spiro [4.5]dec-6-en-7-yl)pent-4-en-1-one; 1,1,2,3,3-pentamethyl-2,3,6,7-tetrahydro-1-inden-4(5)-one; decanal; 2-methyl decanal ; undec-10-enal; undecanal; 2-methylundecanal; 1-methyl-4-(prop-1-en-2-yl)cyclohex-1-ene; 1-methyl-4-(prop-1-en-2-yl)cyclohex-1-ene; 1-methyl-4-(propan-2-ylidene)cyclohex-1-ene; 2-(isopropyl 2-methyl butanoate; 2-(1-(3,3-dimethylcyclohexyl)ethoxy)-2-methylpropyl cyclopropanecarboxylate; 2-(2-(4-methylcyclohex-3-en-1-yl)propyl)cyclopentanone; 2-(2,4-dimethylcyclohexyl)pyridine; 2-(sec-butyl)cyclohexanone; 2-(tert-butyl)cyclohexyl acetate; 2,2,2-trichloro-1-phenylethyl acetate; 2,2,5-trimethyl-5-pentylcyclopentanone; 2,2-dimethyl-2-pheylethyl propanoate; 2,4,6-trimethyl-4-phenyl-1,3-dioxane; 2,4,6-trimethyl cyclohex-3-enecarbaldehyde; 2,6,10-trimethylundec-9-enal; 2,6-dimethylhept-5-enal; 2,6-dimethylheptan-2-ol; 2-cyclohexylidene-2-(o-tolyl)acetonitrile; 2-cyclohexylidene-2-phenylacetonitrile; 2-ethyl-methyl-(m-tolyl)butanamide; 2-isopropyl-5-methylcyclohexanone; 2-methyl -4-methylene-6-phenyltetrahydro-2-pyran; 2-methyldecanenitrile; 2-pentylcyclopentanone; 3-(3-isopropylphenyl)butanal; 3-(4-(tert-butyl)phenyl)-2-methylpropanal ; 3-(4-ethylphenyl)-2,2-dimethylpropanal ; 3-(4-isobutyl-2-methylphenyl)propanal; 3-(4-isobutylphenyl)-2-methylpropanal; 3,7-dimethyloct-6-en-1-ol; 3,7-dimethyloct-6-enal; 3,7-dimethylocta-1,6-dien-3-ol ; 3,7-dimethyloctan-3-ol; 4-(4-methylpent-3-en-1-yl)cyclohex-3-enecarbaldehyde; 4-(tert-pentyl)cyclohexanone; 4,4 a, 5,9b -tetrahydroindeno[1,2-d][1,3]dioxine; 4-cyclohexyl-2-methylbutan-2-ol; 5-(sec-butyl)-2-(2,4-dimethylcyclohex-3-en-1-yl)-5-m ethyl -1,3-dioxane; 5-tert-butyl-2-methyl-5-propyl -2-furan; 6-(sec-butyl)quinoline; 6, 8-dimethylnonan-2-ol ; 6-ethyl-3-methyloct-6-en-1-ol; 8-(sec-butyl)-5,6,7, 8-tetrahydroquinoline; 8, 8-dimethyl -1,2,3,4,5,6,7, 8-octahydronaphthalene-2-carbaldehyde; allyl 2-(cyclohexyloxy)acetate; dec-4-enal; dec-9-en-1-ol; dodec-2-enal; dodecanal; dodecanenitrile; ethyl 2-ethyl-6,6-dimethylcyclohex-2-enecarboxylate; ethyl 2-methylpentanoate; ethyl octanoate; hex-3-en-1-yl methyl carbonate; hexyl 2-hydroxybenzoate; methyl 3-oxo-2-pentylcyclopentaneacetate; oxacyclohexadecan-2-one; and the like.

The spray-dried particles may include from about 0.5% to about 50%, in another embodiment from about 1% to about 30%, in yet another embodiment about 25%, or any individual number within the range, by weight of the particle of at least one active component. In one embodiment, the level of free active component, (i.e. surface oil level) is lower than about 1.5%, in another embodiment lower than about 1%, in another embodiment lower than about 0.3% and in yet another embodiment lower than about 0.15% by weight of the spray-dried particles. Surface oil level should be minimized. The amount of surface oil that can be tolerated without negative impact on processing and/or encapsulation performance will depend on the composition of the flavour which will determine its volatility and oxidation stability. Lower oil loading and increasing the emulsifier level will help to reduce surface oil. For higher oil loadings the addition of plasticizer such as fruit or vegetable concentrates containing natural sugars and food acids will help reduce surface oil.

The spray-dried particles according to the present disclosure may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed. It may be placed in the mouth before being consumed, or it may be held in the mouth for a period of time before being discarded.

Broadly, consumables include, but are not limited to, comestibles of all kinds, confectionery products, baked products, sweet products, savoury products, fermented products, dairy products, beverages, oral care products, nutraceuticals and pharmaceuticals.

Exemplary comestibles include, but are not limited to, chilled snacks, sweet and savoury snacks, fruit snacks, chips/crisps, extruded snacks, tortilla/corn chips, popcorn, pretzels, nuts, other sweet and savoury snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, meat analogues, frozen pizza, chilled pizza, soup, canned soup, dehydrated soup, instant soup, chilled soup, UHT soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

Exemplary confectionery products include, but are not limited to, chewing gum (which includes sugarized gum, sugar-free gum, functional gum and bubble gum), centerfill confections, chocolate and other chocolate confectionery, medicated confectionery , lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, combinations of one or more of the above, and edible flavour compositions incorporating one or more of the above.

Exemplary baked products include, but are not limited to, alfajores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savoury biscuits and crackers, bread substitutes.

Exemplary sweet products include, but are not limited to, breakfast cereals, ready-to-eat (“rte”) cereals, family breakfast cereals, flakes, muesli, other ready to eat cereals, children's breakfast cereals, hot cereals.

Exemplary savoury products include, but are not limited to, salty snacks (potato chips, crisps, nuts, tortilla-tostada, pretzels, cheese snacks, corn snacks, potato-snacks, ready-to-eat popcorn, microwaveable popcorn, pork rinds, nuts, crackers, cracker snacks, breakfast cereals, meats, aspic, cured meats (ham, bacon), luncheon/breakfast meats (hotdogs, cold cuts, sausage), tomato products, margarine, peanut butter, soup (clear, canned, cream, instant, ultrahigh temperature “UHT”), canned vegetables, pasta sauces.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, soy-based desserts.

Exemplary beverages include, but are not limited to, flavoured water, soft drinks, fruit drinks, coffee-based drinks, tea-based drinks, juice-based drinks (includes fruit and vegetable), milk-based drinks, gel drinks, carbonated or non-carbonated drinks, powdered drinks, alcoholic or non-alcoholic drinks, and ready to drink liquid formulations of these beverages.

Exemplary fermented foods include, but are not limited to, cheese and cheese products, meat and meat products, soy and soy products, fish and fish products, grain and grain products, fruit and fruit products.

The spray-dried particles according to the present disclosure may be used in a wide variety of applications besides the food-related consumables mentioned hereinabove. In one embodiment, the spray-dried particles may be used in fragrance applications and especially in applications wherein a burst-like fragrance release is desired. There are numerous examples of situations, where such triggered release is desired by consumers. For example, the spray-dried particles may be admixed with a powder detergent, and the fragrance released when this mixture is added to water. Alternatively, the spray-dried particles may be used everywhere wherein moisture is involved, such as deodorant products, toilet blocs, dish wash tablets, pet litters, diapers and sanitary napkins, feminine hygiene products, mouth hygiene products such as denture cleaning tablets and toothpastes and the like.

The particles according to the present disclosure may be produced using standard spray drying equipment and typical conditions known to the art. In another embodiment, particles according to the present disclosure may be produced using multistage diyer (MSD) equipment and typical conditions known in the art. Conditions may naturally vary depending on the nature of the equipment and the material being sprayed, but the person skilled in the art can readily determine the appropriate conditions in every case with only routine experimentation. Typical examples of conditions that produce dry powder with a moisture content of less than 5% and water activity in the desirable range of from 0.05 to 0.30 at 25° C. Water activity (A_{w}) is the partial vapor pressure of water in a substance divided by the standard state partial vapor pressure of water. It is a measurement of the relative humidity of the sample in a closed chamber—basically is is the equilibrium humidity emitted by the sample material.

Typical parameters for use on a conventional tower spray dryer are:

Inlet temperature—100-250° C.

Outlet temperature—60-120° C.

The finished material size should be 10-300 um mean diameter by volume distribution. as measured by laser diffraction particle size instrument. Other non-limiting examples of suitable drying techniques include fluid bed drying, freeze drying, filtermat and drum drying.

The disclosure is further described with reference to the following non-limiting; examples.

### EXAMPLES

The following examples are given solely for the purpose of illustration and are not to be construed as limitations of the present invention, as many variations of the invention are possible without departing from the spirit and scope of the present disclosure.

### Example 1

### Emulsion Utilizing Flavour Oil (Parsley)

The first emulsion includes a commercially available matrix including Capsul® 1450, a sodium octenyl succinate-modified starch and a maltodextrin (DE 19) (Example A—control) used to encapsulate a parsley flavour. The second and third emulsions include the same parsley flavour encapsulated in a foodstuff matrix according to the present disclosure (Examples B and C).

Emulsions were prepared from the ingredients listed below:

TABLE 1

| | Ex. A | | |
|---|---|---|---|
| Ingredients (g) | (Control) | Ex. B | Ex. C |
| Water | 468 | 500 | 347.5 |
| Parsley Flavour¹ | 133 | 125 | 125 |
| Potato Protein | | 19 | 19 |
| Caspul ® 1450 | 79.8 | | |
| Glucose Syrup | | 356 | |
| Soluble Fiber² | | | 508.5 |
| Maltodextrin (DE 19) | 319.2 | | |

¹Commercial flavour avilable from Givaudan Flavors Corporation
²Promitor 70L

Emulsions according to the present disclosure were prepared as follows: Potato protein and filler (glucose syrup and/or soluble fiber) were dissolved in water. The volatile active component was added to the water phase containing the dissolved emulsifier and filler under high shear mixing, for example, IKA mixer, 8000 rpm for five minutes, to create an emulsion. The compositions of the samples are reported on Table 1. The emulsions are then spray-dried using an Anhydro PSD55 spray drying unit equipped with a rotary atomizer and a peristaltic delivery pump. Inlet and outlet temperatures were respectively 170° C. (±5° C.) and 95° C. (±3° C.). The powder was recovered by means of a cyclone separator.

### Example 2

### Emulsion Utilizing Flavour Oil (Basil)

The first emulsion includes a commercially available matrix including Capsul® 1450, a sodium octenyl succinate-modified starch and a maltodextrin (DE 19) (Example D—control) used to encapsulate a basil flavour. The second and third emulsions include the same basil flavour encapsulated in a foodstuff matrix according to the present disclosure (Examples B and C).

Emulsions were prepared from the ingredients listed below:

TABLE 2

| | Ex. D | | |
|---|---|---|---|
| Ingredients (g) | (Control) | Ex. E | Ex. F |
| Water | 468 | 500 | 347.5 |
| Basil Flavour¹ | 133 | 125 | 125 |
| Potato Protein | | 19 | 19 |
| Caspul ® 1450 | 79.8 | | |
| Glucose Syrup | | 356 | |
| Soluble Fiber² | | | 508.5 |
| Maltodextrin (DE 19) | 319.2 | | |

¹Commercial flavour avilable from Givaudan Flavors Corporation
²Promitor 70L

Emulsions according to the present disclosure were prepared as follows: Potato protein and filler (glucose syrup and/or soluble fiber) were dissolved in water. The volatile active component was added to the water phase containing the dissolved emulsifier and filler under high shear mixing, for example, IKA mixer, 8000 rpm for five minutes, to create an emulsion. The compositions of the samples are reported on Table 2. The emulsions are then spray-dried using an Anhydro PSD55 spray drying unit equipped with a rotary atomizer and a peristaltic delivery pump. Inlet and outlet temperatures were respectively 170° C. (±5° C.) and 95° C. (±3° C.). The powder was recovered by means of a cyclone separator.

### Stability Results

The various particles from Examples A-F were analyzed for % total oil retention by determining the proportion of key flavour ingredients remaining after various periods of storage. The samples were stored at 40° C. and 30% relative humidity in LDPE bags of a type that did not provide a barrier to moisture absorption. Samples were analyzed by GC. The results are shown in Table 3 (Parsley) and Table 4 (Basil) below.

TABLE 3
Oil Retention (Parsley)

| Ex. | Key | | | | |
|---|---|---|---|---|---|
| No. | Ingredients | Initial | 4-Weeks | 8-Weeks | 16-Weeks |
| A | Pinene alpha | 12.7 | 8 | 5.7 | 3.7 |
| | Phellandrene | 0.22 | 0.01 | 0.02 | 0.02 |
| | alpha | | | | |
| | Myrcene | 0.92 | 0.27 | 0.16 | 0.08 |
| | Para cymene | 0.67 | 0.69 | 0.65 | 0.62 |
| | Terpinolene | 0.28 | 0.03 | 0.04 | 0.03 |
| | Hexen-3-ol | 1.6 | 1.18 | 0.92 | 0.59 |
| | Para iso | 1.09 | 0.41 | 0.24 | 0.12 |
| | propenyl | | | | |
| | toluene | | | | |
| | Total | 17.48 | 10.59 | 7.73 | 5.16 |
| | | | | | (30% |
| | | | | | remaining; |
| | | | | | 70% loss) |
| B | Pinene alpha | 11.8 | 10 | 9 | 7.5 |
| | Phellandrene | 0.43 | 0.19 | 0.16 | 0.09 |
| | alpha | | | | |
| | Myrcene | 1.06 | 0.59 | 0.45 | 0.25 |
| | Para cymene | 0.51 | 0.56 | 0.58 | 0.58 |
| | Terpinolene | 0.52 | 0.25 | 0.2 | 0.12 |
| | Hexen-3-ol | 1.65 | 1.42 | 1.29 | 1.07 |
| | Para iso | 1.16 | 0.76 | 0.61 | 0.41 |
| | propenyl | | | | |
| | toluene | | | | |
| | Total | 17.13 | 13.77 | 12.29 | 10.02 |
| | | | | | (58.5% |
| | | | | | remaining; |
| | | | | | 41.5% loss) |
| C | Pinene alpha | 11.3 | 10.50 | 9.80 | 9.10 |
| | Phellandrene | 0.47 | 0.36 | 0.28 | 0.18 |
| | alpha | | | | |
| | Myrcene | 1.02 | 0.66 | 0.45 | 0.33 |
| | Para cymene | 0.45 | 0.48 | 0.51 | 0.53 |
| | Terpinolene | 0.57 | 0.39 | 0.33 | 0.25 |
| | Hexen-3-ol | 1.59 | 1.46 | 1.36 | 1.23 |
| | Para iso | 1.12 | 0.86 | 0.72 | 0.56 |
| | propenyl | | | | |
| | toluene | | | | |
| | Total | 16.52 | 14.71 | 13.45 | 12.18 |
| | | | | | (74% |
| | | | | | remaining; |
| | | | | | 26% loss) |

Table 3 shows the proportion of key ingredients remaining. For parsley (which is sensitive to oxidation) a loss of less than 50% of the original proportion was acceptable. Higher oil retention percentage indicates better encapsulation performance. The encapsulation performance of Examples B and C, which contained the flavour oil encapsulated in a foodstuff matrix were better compared to Example A (control).

TABLE 4
Oil Retention (Basil)

| Ex. | Key | | | | |
|---|---|---|---|---|---|
| No. | Ingredients | Initial | 4-Weeks | 8-Weeks | 16-Weeks |
| D | Hexen-3- | 2.19 | 2.09 | 2.2 | 2.12 |
| | ol-1,cis | | | | |
| | Eucalyptol | 0.78 | 0.75 | 0.74 | 0.74 |
| | Linalool | 2.77 | 2.67 | 2.65 | 2.58 |
| | Eugenol | 6.39 | 6.01 | 5.57 | 5.21 |
| | Total | 12.13 | 11.52 | 11.16 | 10.65 |
| | | | | | (88% |
| | | | | | remaining; |
| | | | | | 12% loss) |
| E | Hexen-3- | 2.19 | 2.18 | 2.24 | 2.25 |
| | ol-1,cis | | | | |
| | Eucalyptol | 0.75 | 0.74 | 0.74 | 0.74 |
| | Linalool | 2.6 | 2.65 | 2.69 | 2.71 |
| | Eugenol | 5.98 | 5.94 | 5.88 | 5.55 |
| | Total | 11.52 | 11.51 | 11.55 | 11.25 |
| | | | | | (98% |
| | | | | | remaining; |
| | | | | | 2% loss) |
| F | Hexen-3- | 2.06 | 1.91 | 2.01 | 2.05 |
| | ol-1,cis | | | | |
| | Eucalyptol | 0.71 | 0.68 | 0.68 | 0.69 |
| | Linalool | 2.46 | 2.41 | 2.46 | 2.5 |
| | Eugenol | 5.62 | 5.42 | 5.36 | 5.08 |
| | Total | 10.85 | 10.42 | 10.51 | 10.32 |
| | | | | | 95% |
| | | | | | remaining; |
| | | | | | 5% loss) |

Table 4 shows the proportion of key ingredients remaining. For basil, a loss of less than 10% of the original proportion was acceptable. Higher oil retention percentage indicates better encapsulation performance. The encapsulation performance of Examples B and C, which contained the flavour oil encapsulated in a foodstuff matrix were better compared to Example A (control).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Stable spray-dried particles comprising:
a water-soluble foodstuff matrix including from about 0.1% to about 60% emulsifier and from about 40% to about 99.9% filler, based on the total weight of the foodstuff matrix; and
at least one active component encapsulated in the foodstuff matrix;
wherein the emulsifier is potato protein and the filler is selected from the group consisting of glucose syrup, soluble fibers and mixtures thereof

2. The stable spray-dried particles according to claim 1, wherein the soluble fibers are derived from corn.

3. The stable spray-dried particles according to claim 1, wherein the emulsifier is present in an amount of from about 0.5% to about 30%, based on the total weight of the foodstuff matrix.

4. The stable spray-dried particles according to claim 1, wherein the at least one active component is selected from flavour and fragrance ingredients.

5. The stable spray-dried particles according to claim 4, wherein the at least one active component is present in an amount of from about 1% to about 30%, based on the total weight of the foodstuff matrix.

6. A delivery system comprising the stable spray-dried particles according to claim 1.

7. A consumable comprising the stable spray-dried particles according to claim 1.

8. Stable spray-dried particles comprising:
a water-soluble foodstuff matrix including from about 0.1% to about 60% emulsifier and from about 40% to about 99.9% filler, based on the total weight of the foodstuff matrix; and
at least one flavour ingredient encapsulated in the foodstuff matrix;
wherein the emulsifier is selected from the group consisting of beef stock protein, beef bone marrow extract, chicken stock protein, chicken gelatin, citrus pectin, egg yolk, albumin, gelatin hydrolysate, pork stock protein, sugar beet pectin, turkey stock protein, whey protein concentrate, soy protein, yogurt, non-fat milk solids, quillaja, pea protein, chickpea protein, rice bran proteins and mixtures thereof; and the filler is selected from the group consisting of glucose syrup, soluble fibers and mixtures thereof.

9. A process for preparing stable spray-dried particles, comprising the steps of:
a) preparing a water-soluble foodstuff matrix including from about 0.1% to about 60% potato protein and from about 40% to about 99.9% filler;
b) dissolving the foodstuff matrix in water;
c) adding an active component;
d) mixing the foodstuff matrix and active component under high shear to form an emulsion; and
e) drying the emulsion.

10. The process for preparing stable spray-dried particles according to claim 9, wherein the drying is spray drying.

11. The process for preparing stable spray-dried particles according to claim 9, wherein the filler is selected from the group consisting of glucose syrup, soluble fibers and mixtures thereof.
